(19) United States
(12) Patent Application Publication
(10) Pub. No.: US 2017/0117981 A1
(43) Pub. Date: Apr. 27, 2017

(54) Optical Wavelength Multiplexer and Demultiplexer

(71) Applicants: Jinghui Li, Sierra Madre, CA (US); Jinhe Qiu, Shenzhen (CN); Qiang Zhou, Shenzhen (CN); Yaozhong Lin, Shenzhen (CN); Wen Lu, Shenzhen (CN)

(72) Inventors: Jinghui Li, Sierra Madre, CA (US); Jinhe Qiu, Shenzhen (CN); Qiang Zhou, Shenzhen (CN); Yaozhong Lin, Shenzhen (CN); Wen Lu, Shenzhen (CN)

(73) Assignee: Jinghui Li, Duarte, CA (US)

(21) Appl. No.: 14/921,527

(22) Filed: Oct. 23, 2015

(51) Int. Cl. H04J 14/02; H04Q 11/00

(52) U.S. Cl. CPC H04J 14/0212; H04Q 11/0005; H04Q 2011/0016

(57) ABSTRACT

An optical wavelength multiplexer/demultiplexer is disclosed to use double reflections on the same filter twice through help of a mirror to enhance the reflection channel isolation without comprising optical performance. It employs only one filter and one mirror on a support substrate. The optical wavelength multiplexer/demultiplexer offers a smaller size than a conventional one and lower cost of manufacturing.

### BACKGROUND OF THE INVENTION

a. Field of the invention

The present invention generally relates to the area of optical telecommunication. Specifically, the present invention relates to micro optical devices, modules, and assemblies for multiplexing and/or demultiplexing light beams and method of making thereof. Examples of the optical devices, modules, or assemblies may include, but not limited to, multiplexers and demultiplexers.

b. Background of Related Art

Optical modules such as CFP, CFP2, CFP4, and Quad Small-Form factor Pluggable (QSFP28) are used in 40G/100G telecommunication network, which generally requires a device, such as a multiplexer/demultiplexer, to multiplex several individual wavelength signals from different channels or a group of channels into a fiber, and/or to demultiplex such signals in a reverse direction. In general, CFP2/4 or QSFP28 with four independent channels interfacing network hardware to a fiber optic cable is very compact in size and sensitive in price. Hence, minimizing the size and reducing the cost of multiplexer/demultiplexer used in CFP2/4 or QSFP28 without compromising optical performance such as insertion loss and isolation are the top two priorities for rivals in the market.

FIG. 5 illustrated isolation of a single reflection by thin film bandpass WDM filter is only around 15 dB like in Point C, which is much lower comparing to isolation of a transmission that is usually over 30 dB like Point A and B. Take a 3-port WDM demultiplexer in prior art as an example, a light beam with combined λ1 and λ2 wavelengths is incident onto a thin film bandpass filter. Under this circumstance, isolation at the transmission port between wavelength λ1 and wavelength λ2 is about 30 dB. In contrast, isolation at the reflection port between wavelength λ2 and wavelength λ1 is only about 15 dB, meaning isolation of the thin film bandpass filter for transmission and reflection signals is very different. However, in application, requirement for isolation between two wavelength signals need to be high, typically around 30 dB, in order to avoid possible crosstalk between the two wavelength signals. Nowadays public depends on the internet for higher and higher data transmission rate at a lower cost. As a result, finding a solution for optical multiplexer/demultiplexer with improved quality, high isolation between neighboring wavelengths, that may be manufactured with reduced cost in a simplified production process, is getting more and more important.

The currently existing 100 Gb/s transmission is usually achieved by using 4 wavelength, each wavelength carries 25 Gb/s signals. One of technology of the next generation cost reduction transmission is likely to be PAM-4 (Pulse Amplitude Modulation), which uses four distinctive amplified levels, representing two bits of four groups, (00), (01), (10), (11) instead of 1 and 0 in prior art. Because of the improvement, data transmission rate can be twice as fast as before, therefore the required number of wavelengths may be reduced from 4 wavelengths (4×25 Gb/s) to 2 wavelengths (2×50 Gb/s) to achieve a 100 Gb/s transmission system. Similarly, the next generation 400 Gb/s could use the PAM-4 technology to reduce the total wavelength number from 16 (25 Gb/s each) to 8 (50 Gb/s), or even 8 (50 Gbs/) to 4 (100 Gb/s). This new transmission scheme could help reduce the cost of multiplexing/demultiplexing WDM signals.

In the existing art, standard components of a multiplexer usually include a support substrate with a high reflective coating and an antireflective coating alongside on an incident surface. In addition, two filters may be placed on the opposite side for filtering signals into a wavelength band and reflecting the others in the meantime. FIG. 1 are illustrations of top, side, and perspective views of a multiplexer/demultiplexer known in the art. In FIG. 2, a multiplexed wavelength light beam L traveling from a common port passes through the antireflective coating 210 into the support substrate 200 and to a filter 212. The first filter 212 split the multiplexed wavelength light beam L into two light beams, transmitting the first wavelength light beam L0 and reflecting the second wavelength light beam L1 to the mirror 214 attached alongside the antireflective coating 210 on the incident surface 202. Reflected by the mirror 214, the second wavelength light beam L1 passes through the second filter 216 on the second surface to an output channel as the same direction of L1. Specifically, the first filter 212 and the second filter 216 transmit different wavelength signals.

One disadvantage of the above prior art multiplexer/demultiplexer is the size thereof, which is usually large. In addition, it depends on the length of the support substrate, depends on the angle θ (such as 8 degree) of the edge between the incident surface and the bottom of the support substrate, depends on the space of output channels between light beams L0 and L1, and depends on the number of times of reflection on the filters. Furthermore, the isolation of the light beam is related and/or affected by the isolation of the filter. Accordingly, there is a great need for a new design if it provides smaller, higher optical performance solution, and could be employed without changing the existing setup.

### SUMMARY OF THE INVENTION

Embodiments of present invention provide improvement in a multiplexer that makes it possible to be installed in an existing network system without adjusting the hardware. More specifically, by removing one of filters and making it at least two reflections on a filter through a mirror to improve the isolation in reflections, the isolation in reflection may double through double reflections on a bandpass filter. For example, in FIG. 5, isolation between WDM wavelength signals may be boosted from Point C′ to Point A′ that is enhanced from 15 dB to 30 dB between Ch1 and Ch2 with this simple modification. This invention not only reduces cost and dimensions of an optical multiplexer/demultiplexer but also creates an efficient way to boost performance of an optical multiplexer/demultiplexer for the next generation data transmission technology, such as PAM-4. This invention uses two reflections by the same filters which offers two identical wavelength dependent reflections. Therefore, the reflection isolation could be doubled. This is different from the convention mirror reflections, which is wavelength independent and offers no isolation at all. It's also different from the regular WDM filter reflections which offer the multiple reflections by the multiple filters, each reflection is different in wavelength, results in no isolation enhancement.

An optical multiplexer/demultiplexer is disclosed for splitting a multiplexed wavelength light beam into separate wavelength bands and emitting into different channels. The multiplexer/demultiplexer includes a support substrate that has a first surface and a second surface for guiding a multiplexed wavelength light beam traveling along an optical propagating path, an antireflective coating adhered on the first surface for receiving the multiplexed wavelength light beam that incidents from a common port, a filter adhered on the second surface for receiving the multiplexed wavelength light beam traveling from the first surface. The filter in-turn outputs a light beam in a first wavelength band and reflects the other light beam in a second wavelength band to a mirror. The mirror is adhered on the first surface alongside the antireflective coating for receiving and reflecting the light beam in the second wavelength band to the filter back and forth with at least two reflections happening on the same filter through the mirror inside the optical multiplexer/demultiplexer. The light beam in the second wavelength band latter exits through an output channel.

Specifically, one advantage of the invention is the reduced size of the multiplexer/demultiplexer which does not cause any compromise in optical performance such as insertion loss and isolation of a signal.

Also, the invention disclosed a multiplexing/demultiplexing method for separating a multiplexed wavelength light beam into several wavelength bands and emitting to different channels. The method includes causing a multiplexed wavelength light beam to transmit through an antireflective coating adhered on a first surface of a support substrate, which has the first surface and a second surface parallel to each other. The light is then split by a filter attached on the second surface into two light beams in different wavelength bands. A light beam in the first wavelength band passes through the filter; and a light beam in the second wavelength band is reflected back and forth between a mirror adhered on the first surface and the filter; at least two reflections respectively happen on the filter and the mirror; and lately the light beam in the second wavelength band passes to a output channel.

The other object of an optical multiplexer is that simplifying in design and economic in manufacturing by reducing optical components.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 shows illustrations of top, side, and perspective views of a standard multiplexer known in the art.

FIG. 2 illustrates a multiplexed wavelength light beam traveling in a prior art of a standard multiplexer.

FIG. 3 are illustrations of top, side, perspective views of a multiplexer according to one preferred embodiment.

FIG. 4 illustrates a multiplexed wavelength light beam traveling in the preferred embodiment.

FIG. 5 illustrates the previous arts two filter transmission spectrum and the current invention of single filter transmission and double reflection spectrum.

### DETAILED DESCRIPTION OF THE PREFERRED EMBODIMENT

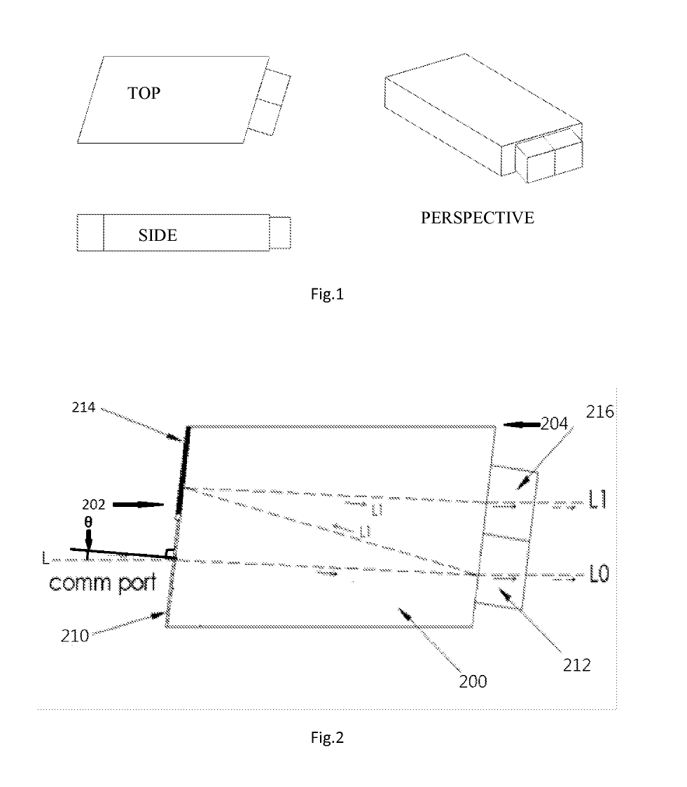

In FIG. 2, the prior art of a multiplexer generally comprises two filters, an antireflective coating, and a mirror on a support substrate connecting an input optical fiber to the common port for the incoming light beam and two output optical fibers or output channels for guiding two wavelength light beams in the first wavelength band LO and in the second wavelength band L1.

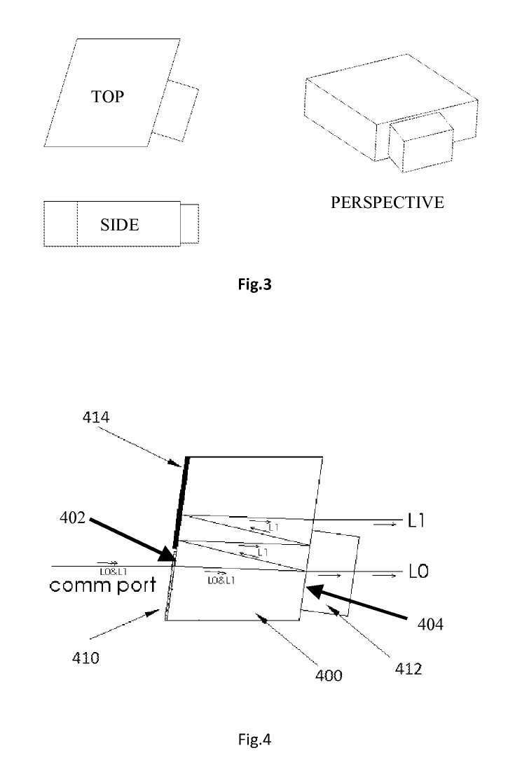

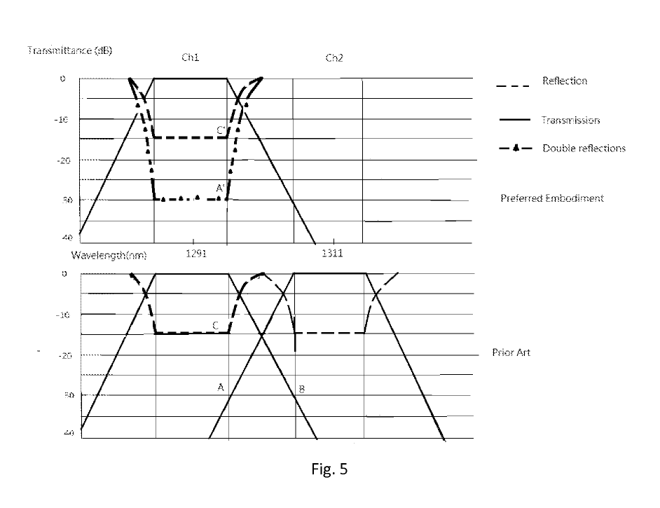

Referring to the drawing in particular, the invention embodies therein, in FIG. 3, illustrates three different views of the preferred embodiment of the Invention. In FIG. 4, the preferred embodiment comprises a support substrate 400 with an antireflective coating 410 on the incident surface 402 that transmits a multiplexed wavelength light beam L traveling from a common port , connected with an optical fiber in general knowledge in an incident angle that could be any angle set up by the designer, to a filter 412 attached on the end surface 404 of the incident surface 402 transmitting the wavelength light beams. In the first wavelength band L0 and reflecting wavelength light beams. In the second wavelength band L1 to the mirror 414 attached alongside the antireflective coating 410 on the incident surface 402. Reflected by the filter 412 to a mirror 414, the wavelength light beams in the second wavelength band L1 has at least two reflections respectively on the surfaces of the filter 412 and the mirror 414. In the preferred embodiment, two reflections respectively happened on the surfaces of the filter 412 and the mirror 414 so increases the isolation of two wavelength light beams in the first wavelength band L0 and in the second wavelength band L1. As a result, the length of the preferred embodiment of the invention is reduced to a half of the prior art (With 4.3 mm of the length of the prior art in FIG. 2, the preferred embodiment reduces its length to 2.15 mm) and the isolation of the signal is increased by removing the second filter 216 of the prior art in FIG. 2.

Unambiguously, the antireflective coating 410 is a composition of dielectric materials of high refractive index and low refractive index. The mirror 414 may be a metallic reflective coating or a dielectric high reflective coating, which is a composition of dielectric materials of high refractive index and low refractive index as well.

Any kind of optical fibers can be installed as light guiding fibers for multiplexed wavelength light beam in addition to multimode fibers with a stepped or graded index profile.

While the preferred embodiment of the invention has been demonstrated and described in detail to illustrate the application of the principles of the invention, it will be understood that the invention may be embodied otherwise without departing from such principles.

This invention could also be applied to the optical multiplexing/demultiplexing with more than 2 wavelengths. The last filter could be saved by double reflections of the second-last filter to achieve the same isolation value as the transmission isolation.

What is claimed is:

1. An optical multiplexer/demultiplexer for splitting a multiplexed wavelength light beam into separate wavelength bands and emitting to different channels, comprising
a support substrate that has a first surface and a second surface for guiding a multiplexed wavelength light beam traveling along an optical propagating path;
an antireflective coating adhered on said first surface for receiving the multiplexed wavelength light beam;
a filter adhered on said second surface for receiving said multiplexed wavelength light beam traveling from the first surface, the filter outputs a light beam in a first wavelength band and reflects another light beam in a second wavelength band;
a mirror adhered on said first surface alongside the antireflective coating for receiving and reflecting said another light beam in the second wavelength band to the filter back and forth, and latterly to an output channel; and
at least two reflections respectively happens between the filter and the mirror in the optical multiplexer/demultiplexer.

2. The optical multiplexer/demultiplexer of claim 1, wherein the first surface and the second surface being parallel to each other.

3. The optical multiplexer/demultiplexer of claim 1, wherein the support substrate is a glass substrate or a plastic substrate.

4. The optical multiplexer/demultiplexer of claim 1, wherein the mirror is a metallic reflective coating or a dielectric high reflective coating.

5. A multiplexing/demultiplexing method for separating a multiplexed wavelength light beam into several bands and emitting to different channels, comprising causing a multiplexed wavelength light beam through an antireflective coating adhered on a first surface of a support substrate, which has the first surface and a second surface parallel to each other, the light beam being split by a filter attached on the second surface into a first and a second light beams in different wavelength bands; the first light beam in the first wavelength band passing through the filter;
reflecting the second light beam in the second wavelength band back and forth between a mirror adhered on said first surface and the filter;
causing at least two reflections respectively happening on the filter and the mirror; and lately
causing the second light beam in the second wavelength band passing to an output channel.

6. The optical multiplexer/demultiplexer of claim 5, wherein the first surface and the second surface being parallel to each other.

7. The optical multiplexer/demultiplexer of claim 5, wherein the support substrate is a glass substrate or a plastic substrate.

8. The optical multiplexer/demultiplexer of claim 5, wherein the mirror is a metallic reflective coating or a dielectric high reflective coating.
